(19) United States
(12) Patent Application Publication
(10) Pub. No.: US 2016/0308766 A1
(43) Pub. Date: Oct. 20, 2016

(54) Unified Mapping Tables With Source/Destination Labels For Network Packet Forwarding Systems

(71) Applicant: IXIA, Calabasas, CA (US)

(72) Inventors: Scott Register, Austin, TX (US); Kristopher Raney, Austin, TX (US)

(21) Appl. No.: 14/688,110

(22) Filed: Apr. 16, 2015

(51) Int. Cl. H04L 12/741; H04L 12/723

(52) U.S. Cl. CPC H04L 45/745; H04L 45/50

(57) ABSTRACT

Unified mapping tables with source/destination labels for packet forwarding systems are disclosed. In certain embodiments, local source/destination records are stored, and information from these local source/destination records are exchanged. Source/destination records from different packet forwarding systems are then combined to form unified mapping tables. Source records include general labels, descriptions of packet sources, and packet parameters to identify the source packets. Destination records include general labels, descriptions of packet destinations, and packet parameters to identify the packet destinations. The general source/destination labels are human-readable generalized descriptors that allow users/administrators of packet forwarding systems to more easily configure and define filters that determine how packets are forwarded by the packet forwarding systems. A management component can also be used as part of a central management system to receive local source/destination records and to form a master unified mapping table that can be accessed by the different packet forwarding systems.

### TECHNICAL FIELD OF THE INVENTION

This invention relates to managing network packets and providing visibility for network packet communication systems.

### BACKGROUND

Packet-based data networks continue to grow in importance, and it is often desirable to monitor network traffic associated with these packet-based networks on an ongoing basis. To meet these monitoring needs, copies of network packets can be forwarded to diagnostic network monitoring tools. Packets are often forwarded using network hubs, test access ports (TAPs), and/or switched port analyzer (SPAN) ports available on network switch systems. For example, certain network switch systems produced by Cisco Systems include SPAN ports to which traffic on the switches are mirrored. It is also noted that other packet monitoring or access methods may also be used to acquire copies of network packets being communicated within a network infrastructure.

To help alleviate the problem of limited access to network packets for monitoring, tool aggregation devices or packet broker devices have been developed that allow shared access to the monitored network packets. These tool aggregation devices allow users to obtain packets from one or more network monitoring points (e.g., network hub, TAP, SPAN port, etc.) and to forward them to different monitoring tools. U.S. Pat. No. 8,018,943, U.S. Pat. No. 8,098,677, and U.S. Pat. No. 8,934,495 describe example embodiments for network tool optimizer systems that provide packet forwarding systems for tool aggregation and packet broker solutions and describe in part configuration of user-define filters, automatic creation of filter engine forwarding rules, automatic handling of filter overlaps, graphical user interfaces (GUIs) for filter creation, and other features. U.S. Published Patent Application Number 2014/0254396 describes in part example embodiments for multiple packet forwarding system systems that are combined into a unified packet forwarding system. U.S. Pat. No. 8,018,943, U.S. Pat. No. 8,098,677, U.S. Pat. No. 8,934,495, and U.S. Patent Number 2014/0254396 are each hereby incorporated by reference in its entirety.

When a network to be monitored includes multiple packet forwarding systems such as combinations of the packet forwarding systems described above, however, difficulties can arise in identifying packet sources within the combined network packet forwarding system. Further, when changes are made to packets sources being received and forwarded by one packing forwarding system, these changes can be difficult to track within other packet forwarding systems within the overall combined system. Similarly, changes to packet destinations can also be difficult to track across the overall system. Such changes often require the user/administrator of one packet forwarding system to manually contact the user/administrator of other packet forwarding systems within the overall combined system to make them aware of changes to network packet sources/destinations that have been made and applied to those network packet sources/destinations. Without this manual intervention, packet forwarding filters and associated forwarding rules configured within one packet forwarding system can become broken such that the desired packet sources are no longer received and forwarded as intended within any given packet forwarding system and/or within the overall combined system.

For example, assume that a first packet forwarding system has filter rules configured to identify packet traffic received at a first input port having a particular identifier (e.g., VLAN25 (virtual local area network identifier number 25)) and output these packets to a specified first output port. This stream of packets can be provided to a network monitoring tool connected to the first output port, and this stream of packets can also be provided to a separate output port that provides the packet stream to a second packet forwarding system. Assuming the administrator for the second packet forwarding system is aware that the packet stream includes VLAN25 tagged packets, then filters can be configured within the second packet forwarding system that rely upon this designation. However, if the VLAN25 identifier changes for the desired traffic such as from VLAN25 to VLAN100, and if a modification is made to the filter for the first packet forwarding system to account for this change, the traffic being received by the second packet forwarding system will include a VLAN100 identifier instead of the expected VLAN25 identifier. While the content within the packets may still be from the desired network device, the filters within second packet forwarding system will no longer operate properly as they relied upon the VLAN25 identifier. While this is a relatively simple change, the problem becomes extremely complex and difficult to manage when a large number of filters are defined in the packet forwarding systems and when the filters include more complicated definitions of the packet traffic being selectively forwarded within the combined system.

### SUMMARY OF THE INVENTION

Unified mapping tables with source/destination labels for packet forwarding systems are disclosed. In certain embodiments, local source/destination records are stored by packet forwarding systems, and information from these local source/destination records are exchanged by the packet forwarding systems. Source/destination records from different packet forwarding systems are then combined to form unified mapping tables. Each source record includes a general label, a description of a packet source, and packet parameters configured to identify the source packets from the packet sources. Each destination record includes a general label, a description of a packet destination, and packet parameters configured to identify the packet destination. The general source/destination labels are human-readable generalized descriptors for packet sources and/or packet destinations that allow users/administrators of the packet forwarding systems to more easily configure and define filters that determine how packets are forwarded by the packet forwarding systems. The packet forwarding systems also include user interfaces that allow for the configuration of these filters using the general source/destination labels from the unified mapping tables. Filter engine rules are generated based upon the filters defined for a packet forwarding system, and these rules are applied to filter engines within the packet forwarding system. Packets received by the packet forwarding system are then forwarded from input ports to output ports using the filter engines so that packets are forwarded based at least in part upon the filters. A management component can also be used as part of a central management system to receive local source/destination records and to form a master unified mapping table that can be accessed by the different packet forwarding systems. In further embodiments, the packet forwarding systems can be implemented as virtual machines operating within virtual environments hosted by one or more processing devices. Other features and variations can be implemented, if desired, and related systems and methods can be utilized, as well.

For one embodiment, a method to control forwarding of network packets is disclosed including storing within a packet forwarding system one or more local source records; combining one or more source records from a separate packet forwarding system and the one or more local source records to form a unified mapping table with each source record including a general label, a description of packet sources, and filter parameters configured to identify the source packets from the packet sources; allowing configuration of one or more filters using general labels from the unified mapping table with each filter being configured to determine how packets are forwarded by the packet forwarding system; generating rules for one or more filter engines based upon the one or more filters and the filter parameters within the unified mapping table; applying the rules to the one or more filter engines within the packet forwarding system; receiving packets from a network using the packet forwarding system; and forwarding the received packets using the filter engines within the packet forwarding system so that packets are forwarded based at least in part upon the one or more filters.

In additional embodiments, the method further includes using the packet forwarding system to receive the one or more source records from the separate packet forwarding system and to store the unified mapping table within the packet forwarding system. In other embodiments, the method further includes using a central management system to receive the source records from both the packet forwarding system and the separate packet forwarding system and to store the unified mapping table within the central management system.

In further embodiments, the method further includes exchanging one or more local source records with the separate packet forwarding system. In addition, the method can also include communicating between the packet forwarding system and the separate packet forwarding system to determine commonly supported filter parameters and communicating only commonly supported filter parameters within local records exchanged between the packet forwarding system and the separate packet forwarding system. In other embodiments, the method further includes exchanging additional information about the source packets with the separate packet forwarding system. In addition, the additional information comprises use information by the separate packet forwarding system for the source packets.

In still further embodiments, the method further includes storing within the packet forwarding system one or more local destination records and combining one or more destination records from the separate packet forwarding system and the one or more local destination records within the unified mapping table with each destination record including a general label, a description of a packet destination, and filter parameters configured to identify the packet destination. In addition, the one or more local source records and the one or more local destination records can be stored within a local mapping table within the packet forwarding system.

In other embodiments, the method also includes forwarding packets from one or more output ports for the packet forwarding system to one or more network monitoring tools coupled to the one or more output ports. In additional embodiments, the packet forwarding system includes a virtual machine operating within a virtual environment formed by one or more processing devices. In further embodiments, the method includes allowing comprises providing a graphical user interface to allow configuration of the one or more filters. In still further embodiments, the filter engines include one or more ingress filter engines associated with input ports for the packet forwarding system and one or more egress filter engines associated with output ports for the packet forwarding system.

For another embodiment, a system to control forwarding of network packets is disclosed including a packet switch within a packet forwarding system having filter engines that determine how network packets are forwarded within the packet forwarding system; a unified mapping table including one or more source records from a separate packet forwarding system and one or more local source records from the packet forwarding system with each source record including a general label, a description of packet sources, and filter parameters configured to identify the source packets from the packet sources; a user interface for the packet forwarding system to allow configuration of one or more filters using general labels from the unified mapping table with each filter being configured to determine how packets are forwarded by the packet forwarding system; and a filter processor within the packet forwarding system to generate rules for the filter engines based upon the one or more filters and the filter parameters within the unified mapping table and to apply the rules to the filter engines to forward packets based at least in part upon the one or more filters.

In additional embodiments, the packet forwarding system is configured to receive the one or more source records from the separate packet forwarding system and to store the unified mapping table. In further embodiments, the packet forwarding system also includes a central management system configured to receive the source records from both the packet forwarding system and the separate packet forwarding system and to store the unified mapping table.

In further embodiments, the packet forwarding system is further configured to exchange one or more local source records with the separate packet forwarding system. In addition, the packet forwarding system can also be further configured to communicate with the separate packet forwarding system to determine commonly supported filter parameters and to send only commonly supported filter parameters within the records exchanged with the separate packet forwarding system. In still further embodiments, the packet forwarding system is further configured to communicate with the separate packet forwarding system to determine additional information about the source packets. In addition, the additional information can include use information by the separate packet forwarding system for the source packets.

In still further embodiments, the unified mapping table also includes one or more destination records from the separate packet forwarding system and one or more local destination records from the packet forwarding system with each destination record including a general label, a description of a packet destination, and filter parameters configured to identify the packet destination. In addition, the one or more local source records and the one or more local destination records are stored within a local mapping table within the packet forwarding system.

In other embodiments, one or more output ports for the packet forwarding system are coupled to one or more network monitoring tools. In additional embodiments, the system further includes one or more processing devices configured to provide a virtual environment, and wherein the packet forwarding system comprises a virtual machine configured to operate within the virtual environment. In further embodiments, the user interface is a graphical user interface. In still further embodiments, the filter engines include one or more ingress filter engines associated with input ports for the packet forwarding system and one or more egress filter engines associated with output ports for the packet forwarding system.

Different or additional features, variations, and embodiments can be implemented, if desired, and related systems and methods can be utilized, as well.

### DESCRIPTION OF THE DRAWINGS

It is noted that the appended drawings illustrate only example embodiments of the invention and are, therefore, not to be considered limiting of its scope, for the invention may admit to other equally effective embodiments.

FIG. 1 is a block diagram of an example embodiment for a network environment including a packet forwarding system and one or more mapping tables that facilitate user definition and management of filters.

FIG. 2 is a block diagram of an example embodiment where general source/destination labels from mapping tables are used to configure one or more filters for a filter processor.

FIG. 3A is a block diagram of an example embodiment for a network environment including multiple packet forwarding systems that exchange mapping table information.

FIG. 3B is a diagram of an example embodiment for a communication flow between mapping table exchange engines for two packet forwarding systems.

FIG. 4 is a block diagram of an example embodiment for a network environment where a master unified mapping table is stored within a central management system.

FIG. 5A is a block diagram for an example embodiment for packet forwarding system.

FIG. 5B is a diagram of an example embodiment for a product configuration as well as external connections for an example packet forwarding system.

FIG. 6A is a block diagram of an example embodiment for a virtual machine (VM) host hardware system that communicates with a network such as a packet network communication system.

FIG. 6B is a block diagram of an example embodiment for a server system including multiple VM environments that host VM platforms implementing packet forwarding systems.

### DETAILED DESCRIPTION OF THE INVENTION

Unified mapping tables with source/destination labels for packet forwarding systems are disclosed. In certain embodiments, local source/destination records are stored by packet forwarding systems, and information from these local source/destination records are exchanged by the packet forwarding systems. Source/destination records from different packet forwarding systems are then combined to form unified mapping tables. Each source record includes a general label, a description of a packet source, and packet parameters configured to identify the source packets from the packet sources. Each destination record includes a general label, a description of a packet destination, and packet parameters configured to identify the packet destination. The general source/destination labels are human-readable generalized descriptors for packets sources and/or packet destinations that allow users/administrators of the packet forwarding systems to more easily configure and define filters that determine how packets are forwarded by the packet forwarding systems. The packet forwarding systems also include user interfaces that allow for the configuration of these filters using the general source/destination labels from the unified mapping table. Filter engine rules are generated based upon the filters defined for a packet forwarding system, and these rules are applied to filter engines within the packet forwarding system. Packets received by the packet forwarding system are then forwarded from input ports to output ports using the filter engines so that packets are forwarded based at least in part upon the filters. A management component can also be used as part of a central management system to receive local source/destination records and to form a master unified mapping table that can be accessed by the different packet forwarding systems. In further embodiments, the packet forwarding systems can be implemented as virtual machines operating within virtual environments hosted by one or more processing devices. Different features and variations can be implemented, as desired, and related systems and methods can be utilized, as well.

The disclosed embodiments in part allow for autonomous and/or semi-autonomous packet forwarding systems to interconnect and allow users/administrators to specify more generalized and meaningful descriptions for packet sources and destinations that are not tied to specific architectures or implementations for a particular chassis, device, and/or system. As such, the disclosed embodiments allows users of network visibility systems and related networks that implement the disclosed embodiments to interconnect a packet forwarding system to other packet forwarding systems without requiring detailed operational information about the other systems. The disclosed embodiments include one or more of the following: a mapping table that maps general labels for packet sources and/or destinations to packet filter parameters and other source/destination information, a handshake mechanism through which different systems can exchange source/destination records from their mapping tables with supported packet filter parameters, and/or a management component that provides packet forwarding systems with a single reference point for a master unified mapping table that can be used to manage a large set of interconnected systems. Other variations can also be implemented.

For implementations that include the management component, multiple different packet forwarding systems communicate with the management component to obtain packet source/destination record information from the master unified mapping table that maps human-readable general source/destination labels to particular filter parameters that are then used by each system to generate rules for filter engines that control how packets are forwarded within the system. The different systems can then operate independently while still taking advantage of the central management component to track and manage a master unified mapping table that holds packet source/destination information from the different systems. The central management component operates in part to maintain this master unified mapping table including what packet sources are available from each system, what packet destinations are available for each system, and how other systems can access these packet sources and packet destinations. For implementations that do not include the management component, the different packet forwarding systems exchange packet source/destination information from their respective local mapping tables directly with each other without the central management component. Each packet forwarding system can then store its own unified mapping able. In further implementations, both direct exchange of packet source/destination information among different systems and central management of the unified mapping table can be used in combination with each other. A variety additional and/or different configurations and implementations can also be used while still taking advantage of the unified mapping table embodiments described herein.

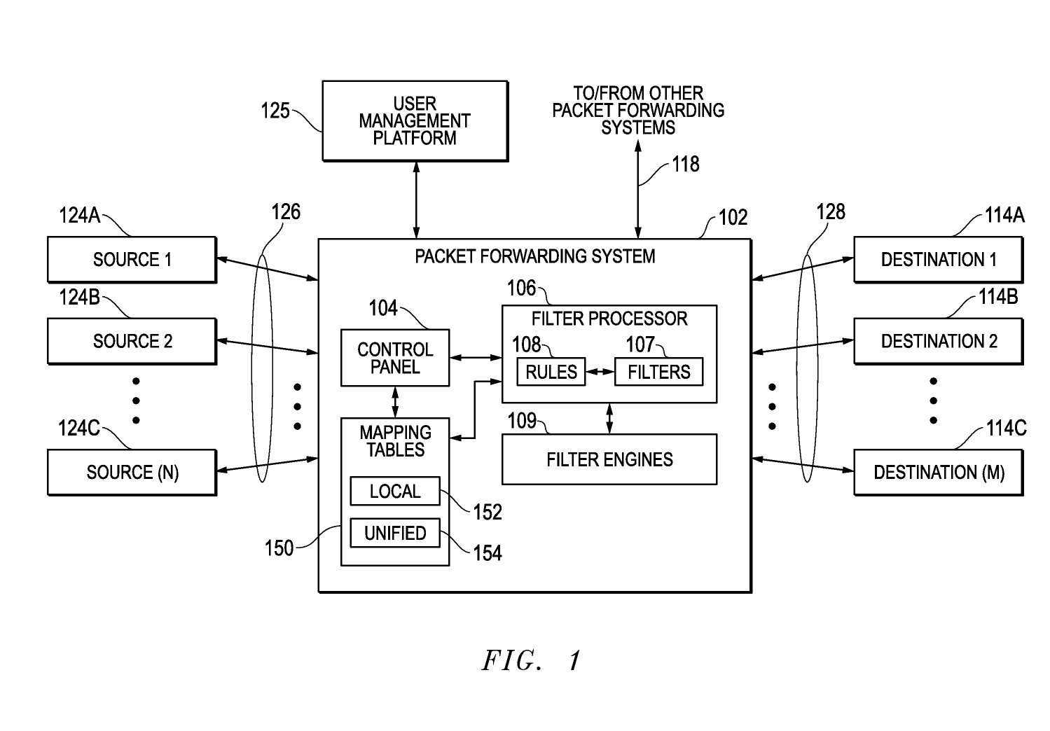

FIG. 1 is a block diagram of an example embodiment for a network environment 100 including a packet forwarding system 102. The packet forwarding system 102 receives copies of packet traffic from one or more sources 124A, 124B . . . 124C through one or more network connections 126 and forwards these packets to one or more destinations 114A, 114B . . . 114C through network connections 128 based upon filter rules 108 applied to filter engines 109. As described in more detail below, the packet forwarding system 102 allows a user or administrator to view, define and/or manage filters 107 through user management platform 125 connected to the system 102 through network connections 127. The filter processor 106 within the packet forwarding system 102 automatically generates the packet forwarding rules 108 based upon the forwarding instructions defined by the filters 107. Once generated, the packet forwarding rules 108 are applied by the filter processor 106 to filter engines 109 to determine how packets are forwarded by the packet forwarding system 102 from input ports that receive network traffic from sources 124A, 124B . . . 124C to output ports that provide packets to the destinations 114A, 114B . . . 114C. The packet forwarding system 102 also includes a control panel 104 that provides user interfaces (UI), such as graphical user interface (GUI), that can be accessed through the user management platform 125 to allow users/administrators to view, create and/or manage the filters 107. The packet forwarding system 102 also communicates with one or more additional packet forwarding systems through network connections 118, for example, to exchange information as described below.

The embodiments described herein include one or more mapping tables 150 that facilitate user definition and management of filters 107. The mapping tables 150 include a local mapping table 152 and a unified mapping table 154. The local mapping table 152 includes one or more source records with each source record having a general label identifying a packet source, a packet stream, and/or another defined group of source packets. The unified mapping table 154 includes source record definitions from the local mapping table 152 and from local mapping tables received from one or more additional packet forwarding systems. The general labels within the source records provide more generalized and easily understood expressions for different packet sources within the network communication system. These general source labels are exposed to users through the user management platform and facilitate user definition and management of filters 107. Further, destination records can also be stored within the local mapping table 152 and the unified mapping table 154. Each destination record includes a general label identifying a packet destination tool and/or another defined destination for packets. As with the source records, the general labels within the destination records provide more generalized and easily understood expressions for different packet destinations within the network communication system. These general destination labels are also exposed to users through the user management platform and facilitate user definition and management of filters 107. As described further below, the filter processor 106 converts filters 107 into filter engine rules 108 that are applied to filter engines 109 to determine how packets are forwarded within the packet forwarding device 102.

The general labels for packet sources and/or packet destinations are human-readable, generalized descriptions for the packet sources and/or packet designations. For example, a general label can be used to represent a network entity that would otherwise be defined by a physical network interface, IP (internet protocol) address or range, TCP (transmission control protocol) or UDP (user datagram protocol) port number, and/or other physical interface or network protocol related parameter. Rather than exchange these more detailed and less understandable physical/protocol definitions, the general labels and related information from the mapping tables 150 are instead exchanged among packet forwarding systems. Further, systems can also communicate with each other, establish protocols/parameters for their interaction, and exchange source/destination records from the local mapping tables that include the general labels. Any of a variety of protocols or techniques can be used for this exchange of information.

It is noted that network visibility solutions, such as packet forwarding system 102, include hardware, software, or combined hardware and software implementations that filter, aggregate, and/or otherwise process packets from a network and make them available to one or more monitoring tools or other devices. According to one aspect of the disclosed embodiments, a packet forwarding system, such as a network tool optimizer (NTO) or packet broker, includes one or more input ports configured to receive network traffic, such as network packets communicated through a packet-based communication network, and one or more output ports configured to provide filtered network traffic to one or more network tools or other devices. The source network traffic provided by connections 126 can be obtained through one of a variety of techniques and devices, such as for example, from network TAPs, from SPAN ports on network switches, and/or from other devices or systems that copy or otherwise obtain packets or packet contents from network traffic flows and make them available for other devices and systems. The network connections and communications described herein can include wired, wireless, and/or combinations of wired and wireless network communications among network-connected devices or systems and can include communications through one or more intervening devices or systems, such as firewalls, routers, switches, and/or other network-connected devices or systems.

It is also noted that the control panel 104 for the packet forwarding system 102 can be implemented as a web interface that can be accessed through a network browser (e.g., MICROSOFT Internet Explorer or MOZILLA Firefox) by other network-connected processing systems. For example, the packet forwarding system 102 can be configured to automatically download a control panel software application to the user management platform 125 when a network browser operating on the user management platform 125 connects to an IP address for the packet forwarding system 102. This download can occur the first time the network browser connects, and the control panel 104 can then be stored locally by the user management platform 125. The user management platform 125 can be, for example, personal computer systems, server systems, and/or other processing systems running WINDOWS operating systems, LINUX operating systems, and/or other operating system as desired. In one embodiment, the control panel 104 can in part be downloaded as JAVA-based software code or modules. Other implementations could also be implemented.

It is further noted that the network traffic sources 124A, 124B . . . 124C can include any of a wide variety of systems that are connected within a network communication system. These systems can include server systems, data storage systems, desktop computer systems, portable computer systems, network switches, broadband routers and/or any other desired processing systems that are connected into a cloud network, as desired. In addition to these systems, any number of network traffic destinations 114A, 114B . . . 114C can also be connected within the network communication system. Further, when implemented as network monitoring tools, the network traffic destinations 114A, 114B . . . 114C be can any of a wide variety of network related tools including traffic monitoring devices, packet sniffers, data recorders, voice-over-IP monitors, intrusion detection systems, network security systems, application monitors and/or any other desired network management or security tool device or system. Still further, as described herein, the sources 124A, 124B . . . 124C, the destinations 114A, 114B . . . 114C, the packet forwarding system 102, and/or the user management platform 125 can be implemented as virtual machines or instances within a virtual processing environment within a larger computing platform. It is further noted that the network communications can be based upon any desired protocol or combination of protocols including Ethernet protocols, multi-protocol label switching (MPLS) protocols, FibreChannel (FC) protocols and/or any other desired communication protocol that can be used for network communications including packet-based network communications.

Still further, it is noted that the filters 107 as well as the forwarding engine rules 108 generated by the filter processor 106 can rely upon various portions of the content of network packets for forwarding actions. For example, network packets typically include in part a link layer header (L2), a network layer header (L3), a transport layer header (L4) and a payload, as well as other network layers (e.g., layers within the Open Systems Interconnect (OSI) model for network communications). Information pertinent to forwarding the packet, such as source ID and destination ID and protocol type, is usually found in the packet headers. These packets may also have various other fields and information within them, such as fields including error check information, virtual local area network (VLAN) identifiers, and/or other information that may be matched and used for filtering. Further, information representing the source device may include items such as the IP address of the source device or the MAC (Media Access Control) address of the source device. Similarly, information representing the destination device may be included within the packet such as the IP address of the destination device. It is seen, therefore, that a wide variety of source and destination identifying information may be included within the packets as well as other packet related information along with the data included within the payload of the packet. While the packet forwarding system embodiments described herein are primarily described with respect to packet-based communications and utilize information within these packets to forward the packets, the packet forwarding system embodiments can be configured to operate with respect to other types of communication protocols and are not limited to packet-based networks.

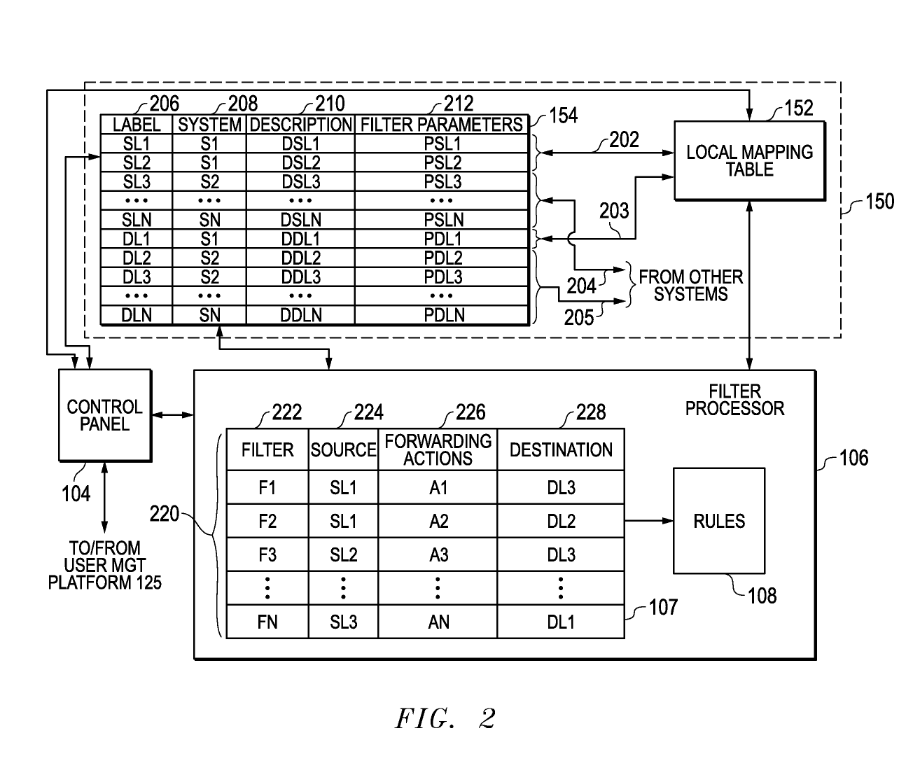

FIG. 2 is a block diagram of an example embodiment where general source/destination labels 206 from mapping tables 150 are used to configure one or more filters 107 for the filter processor 102. For the example embodiment depicted, the unified mapping table 154 includes one or more source label records 202 associated with packet source definitions from the local mapping table 152 as well as source label records 204 associated with packet source definitions from other systems. The unified mapping table 154 also includes one or more destination label records 203 associated with destination packet definitions from the local mapping table 152 as well as destination label records 205 associated with destination packet definitions from other systems. Each source label record 202/204 and each destination label record 203/205 includes a label 206, a system identifier 208, a description 210, and filter parameters 212. Additional and/or different information could also be stored in the unified mapping table 150 and/or within the local mapping table 152.

The source labels (SL1, SL2, SL3 SLN) within labels 206 represent more generalized human-readable descriptors that are used to represent particular packet sources, and the destination labels (DL1, DL2, DL3 DLN) within labels 206 represent more generalized human-readable descriptors that are used to represent particular packet destinations. For example, the labels 206 can be defined and/or selected by a user through interactions with the control panel 104, can be generated by the packet forwarding system 102, and/or formed using some other technique.

The system identifiers (S1, S2 SN) identify the packet forwarding system that is associated with the particular packet sources and/or the packet destinations. For example, assuming local mapping table 152 and the local records 202/203 are from a first packet forwarding system (SYSTEM 1) within a network environment 100, the system identifier for these records 202/203 will include a system identifier (e.g., “S1”) that identifies this first system as being associated with these packet sources and packet destinations. Similarly, separate designations (e.g., “S2 SN”) can be used to identify one or more other systems that are associated with additional packets sources and packet destinations.

The descriptions (DSL1, DSL2, DSL3 DSLN, DDL1, DDL2, DDL3 DDLN) 210 provide short human-readable summaries that describe the packet sources (DSL1, DSL2, DSL3 DSLN) and/or packet destinations (DDL1, DDL2, DDL3 DDLN) for the records within the unified mapping table 154. For easier use, these descriptions can provide human-readable information that describes generally understood types of packets even for those who are not particularly familiar with packet protocols. For example, descriptions such as “email packets from SYSTEM1” or “internet traffic from SYSTEM1” provide human-readable information that is relatively easy to understand with respect to identifying the packet sources and/or packet destinations. These descriptions can also be defined and/or selected by a user through interactions with the control panel 104, can be generated by the packet forwarding system 102, and/or formed using some other technique.

The filter parameters (PSL1, PSL2, PSL3 PSLN, PDL1, PDL2, PDL3 PDLN) 212 include filter parameters associated with the packet sources (PSL1, PSL2, PSL3 PSLN) and packet destinations (PDL1, PDL2, PDL3 PDLN). These filter parameters 212 include one or more parameters that determine the particular packets that are included within the packet sources or provided to the packet destinations. These filter parameters 212, for example, can be used by the filter processor 106 to generate rules 108 from the filters 107. However, because these filter parameters 212 can be difficult to recognize or understand to a user that is managing the packet forwarding system 102, the labels 206 can instead be used within the filter definitions 220 for the filters 107 to represent the packet sources and destinations represented by the records within the unified table 154. The filter processor 106 can then use these labels 206 within the filter definitions 220 to identify the corresponding source/label record within records 202/203/204/205 for the unified mapping table 154 and then access the filter parameters 212 associated with that corresponding record. As indicated above, the filter processor 106 uses the filters 107 and associated filter parameters 212 to generate filter engine rules 108 for the filter engines 109.

As described herein, the filters 107 can be user-defined filters that are formed through user interactions with the control panel 104, for example, though a graphical user interface (GUI). The filters 107 include one or more filter definitions 220 that define details for individual filters. For the embodiment depicted, each row represents a filter definition for a filter and each filter definition includes a filter identifier 222, a source identifier 224, forwarding actions 226, and a destination identifier 228. The filter identifiers (F1, F2, F3 FN) 222 are used to identify different filter definitions. The source identifiers 224 identify the packet sources for each filter definition and can be defined using the general source labels (SL1, SL2, SL3 SLN) within the unified mapping table 154. The forwarding actions (A1, A2, A3 . . . AN) 226 represent one or more actions that are applied by the filter to the packets being forwarded by the filter. The destination identifiers 228 represent the destinations for the packets after being acted upon by the forwarding actions 226 and can be defined using the general destination labels (DL1, DL2, DL3 DLN) within the unified mapping table 154. As described herein, the filter processor 106 processes the filters 107 to generate filter engine rules 108 that are applied to filter engines 109 within the packet forwarding system 102.

The general source labels (SL1, SL2, SL3 SLN) and the general destination labels (DL1, DL2, DL3 DLN), which are both configured to be more easily understood by users, are used for the filter definitions 220 to allow for easier viewing, creation, and management of filters by the user/administrator through interactions with the control panel 104. For example, the first filter definition (Fl) for a first filter provides that source packets identified by a first source label (SL1) are acted upon by first set of forwarding actions (A1) and are provided to a packet destination identified by third destination label (DL3). The second filter definition (F2) for a second filter provides that source packets identified by the first source label (SL1) are acted upon by second set of forwarding actions (A2) and provided to a packet destination identified by a second destination label (DL2). The third filter definition (F3) for a third filter provides that source packets identified by a second source label (SL2) are acted upon by third set of forwarding actions (A3) and are provided to a packet destination identified by the third destination label (DL3). The Nth filter definition (FN) for an Nth filter provides that source packets identified by a third source label (SL3) are acted upon by Nth set of forwarding actions (AN) and are provided to a packet destination identified by a first destination label (DL1). Because the general source/destination labels 206 within the unified mapping table 154 are more easily understood, they allow users/administrators to more easily define and/or modify the filters 107 to cause the filter engines 109 to forward packets as desired by the user/administrator. It is also noted that general destination labels could be used alone, general source labels could be used alone, or combinations of general source and destination labels can be used together.

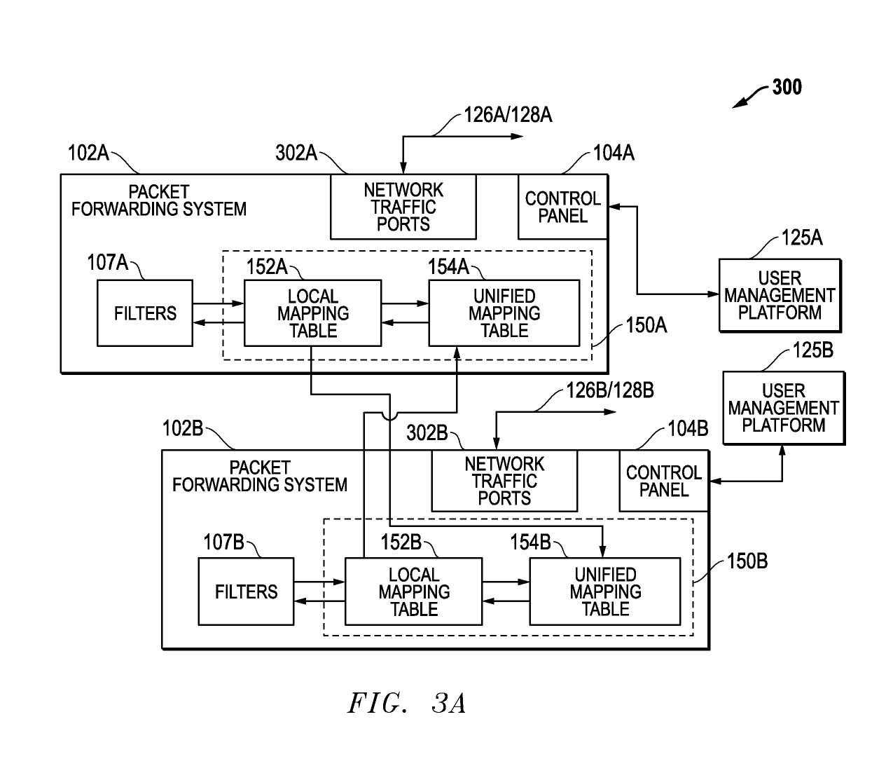

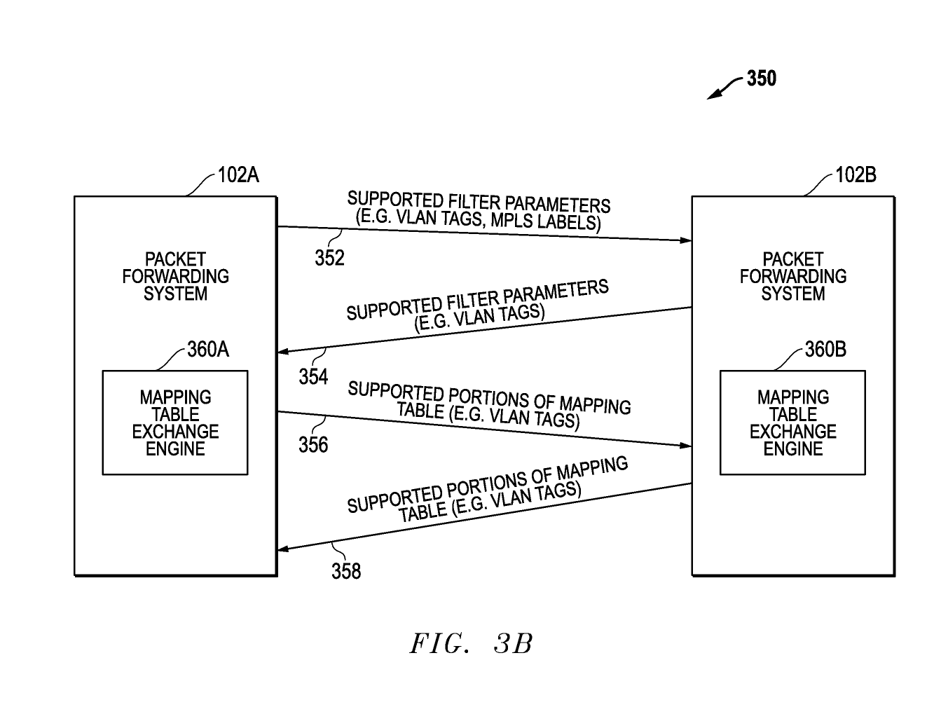

FIG. 3A is a block diagram of an example embodiment for a network environment 300 including multiple packet forwarding systems 102A/102B that exchange mapping table information. For the example embodiment depicted, a first packet forwarding system 102A includes filters 107A and mapping tables 150A including local mapping table 152A and unified mapping table 154A. The first packet forwarding system 102A also includes control panel 104A that communicates with user management platform 125A, and the first packet forwarding system 102A includes network traffic ports 302A that communicate packets through network connections 126A/128A. Similarly, a second packet forwarding system 102B includes filters 107B and mapping tables 150B including local mapping table 152B and unified mapping table 154B. The second packet forwarding system 102B also includes control panel 104B that communicates with user management platform 125B, and the second packet forwarding system 102B includes network traffic ports 302B that communicate packets through network connections 126B/128B.

The packet forwarding systems 102A/102B also communicate with each other to exchange information from their mapping tables 150A/150B. For example, the first packet forwarding system 102A communicates source/destination records from its local mapping table 152A to the second packet forwarding system 102B. The second packet forwarding system 102B can then store information from these source/destination records in its own unified mapping table 154B. Similarly, the second packet forwarding system 102B communicates source/destination records from its local mapping table 152B to the first packet forwarding system 102A. The first packet forwarding system 102B can then store information from these source/destination records in its own unified mapping table 152B. As such, each of the packet forwarding systems 102A and 102B now has generalized source/destination labels and related information for packet sources and/or destinations from the other packet forwarding systems within environment 300. It is further noted that the first and second packet forwarding systems 102A and 102B can communicate with each other through their respective network traffic connections 126A/128A and 126B/128B, through additional control ports, and/or through other techniques.

The following is an example mapping table for the first packet forwarding system 102A. An administrator of the first packet forwarding system 102A, for example, can define the general labels and local definitions within the mapping table. It is noted that the packet filter parameters can also be configured by the administrator or can be generated automatically by the packet forwarding system 102A. For TABLE 1, the first packet forwarding system 102A is implemented in a first chassis (CHASSIS 1).

TABLE 1
EXAMPLE LOCAL MAPPING TABLE FOR SYSTEM 102A

| General Label | Local Definition | Packet Modifier |
|---|---|---|
| Chassis 1, | Packets entering this system | VLAN Tag 1 |
| Port 3 | (Chassis 1) on Network | |
| | Port 3 | |
| Mail Server | Packets to and from server | MPLS Label 4 |
| Traffic | with IP address 192.168.1.5 | |
| | on TCP port 25 | |
| IPS (intrusion | The security server attached | Custom Packet Trailer |
| prevention | to Tool Port 5 on this | 0x0010 |
| system) Server | system (Chassis 1) | |

The following is an example mapping table for the second packet forwarding system 102B. An administrator of the second packet forwarding system 102B, for example, can define the general labels and local definitions within the mapping table. It is noted that the packet filter parameters can also be configured by the administrator or can be generated automatically by the packet forwarding system 102B. For TABLE 2, the second packet forwarding system 102B is implemented in a second chassis (CHASSIS 2).

TABLE 2
EXAMPLE LOCAL MAPPING TABLE FOR SYSTEM 102B

| General Label | Local Definition | Packet Modifier |
|---|---|---|
| Chassis 2, Port 4 | Packets entering this | VLAN Tag 5 |
| | system (Chassis 2) on | |
| | Network Port 4 | |
| Network Recorder | The security server | Custom Packet |
| | attached to Tool Port 2 on | Trailer |
| | this system (Chassis 2) | 0x0011 |

To exchange information from their respective mapping tables 150A/150B, the two packet forwarding systems 102A and 102B perform a handshake operation through the network communication system. One result of this handshake operation is to allow each system to send to the other source/destination information from its respective mapping tables 150A/150B. The received information can then be combined with information from local mapping tables 152A/152B to form unified mapping tables 154A/154B. The user of each respective packet forwarding system 102A/102B can then use the general labels to define local filters without having to know the details of the packet filter parameters associated with the packet sources or packet destinations. Further, the users are not required to manually update filters within their respective packet forwarding systems as the mapping tables can be automatically updated over time through the handshake process.

TABLE 3 below provides an example unified mapping table that includes a combination of information from TABLE 1 and TABLE 2. Such a unified mapping table can be stored at both systems.

TABLE 3
EXAMPLE UNIFIED MAPPING TABLE FOR BOTH SYSTEMS

| General Label | System | Local Definition | Packet Modifier |
|---|---|---|---|
| Chassis 1, Port 3 | CHASSIS 1 | Packets entering Chassis 1 on | VLAN Tag 1 |
| | | Network Port 3 | |
| Mail Server Traffic | CHASSIS 1 | Packets to and from server | MPLS Label 4 |
| | | with IP address 192.168.1.5 | |
| | | on TCP port 25 | |
| IPS Server | CHASSIS 1 | The security server attached to | Custom Packet Trailer |
| | | Tool Port 5 on Chassis 1 | 0x0010 |
| Chassis 2, Port 4 | CHASSIS 2 | Packets entering Chassis 2 on | VLAN Tag 5 |
| | | Network Port 4 | |
| Network Recorder | CHASSIS 2 | The security server attached to | Custom Packet Trailer |
| | | Tool Port 2 on Chassis 2 | 0x0011 |

The example tables below show a sample rule formed on the second packet forwarding system 102B with and without the source/destination labels. As can be seen, the source labels provide a more easily understood expression of the source of the packets that can be used to define the filters. It is assumed that the packet forwarding systems 102A and 102B are interconnected with a network connection so that packets can be sent from one to another.

TABLE 4A
EXAMPLE FILTERS WITH GENERAL LABELS

| Source With Label | Forwarding Actions | Destinations |
|---|---|---|
| Chassis 1, Port 3 | Pass only UDP: 83 | Tool Port 8 |
| Mail Server Traffic | Pass All | Tool Port 2 |

TABLE 4B
EXAMPLE FILTERS WITHOUT GENERAL LABELS

| Source without Label | Forwarding Actions | Destinations |
|---|---|---|
| VLAN Tag 1 | Pass only UDP: 83 | Tool Port 8 |
| MPLS Label 4 | Pass All | Tool Port 2 |

FIG. 3B is a diagram of an example embodiment 350 for a communication flow between mapping table exchange engines 360A and 360B for two packet forwarding systems 102A and 102B. For the example embodiment 350, the mapping table exchange engine 360A for the first packet forwarding system 102A sends a message 352 to the mapping table exchange engine 360B for the second packet forwarding system 102B. This message 352 indicates the filter parameters that are supported by the first packet forwarding system 102A. For purposes of this example, these supported filter parameters are assumed to be VLAN (virtual local area network) tags and MPLS (multi-protocol label switching) labels. The mapping table exchange engine 360B for the second packet forwarding system 102B responds with a message 354 to the mapping table exchange engine 360A for the first packet forwarding system 102A. This message 354 indicates which of the filter parameters supported by the first packet forwarding system 102A are commonly supported by the second packet forwarding system 102B. For purposes of this example, these commonly supported filter parameters are assumed to be VLAN tags. The two packet forwarding systems 102A and 102B then exchange source/destination records including supported filter parameters from their respective mapping tables through messages 356 and 358, respectively. For this example, the commonly shared filter parameters are VLAN tags. As such, the source label records that identify packet sources using VLAN tags can be exchanged as supported portions of the mapping tables. It is also noted that the messages 352, 354, 356, and 358 can be communicated, for example, within network packets transmitted between the two packet forwarding systems 102A and 102B. It is further noted that additional or different communication flow steps can also be used while still taking advantage of the shared source label techniques described herein.

It is noted that a variety of packet filter parameters are available and can be utilized to select packets for forwarding actions. These include, but are not limited to, VLAN tags, MPLS labels, VXLAN (virtual extensible local area network) tags, GRE (generic routing encapsulation) options, custom headers, custom trailers, header modifications, and/or other packet protocol parameters. However, not every packet forwarding system is able to encode, decode, and/or understand every packet protocol parameter. As part of the handshake, therefore, each of the systems 102A/102B can also exchange its list of supported capabilities, and the systems 102A/102B can then agree on a common set of supported parameters to use in exchanging information from mapping tables. For example, per the example of FIG. 3B, a first system 102A may support both VLAN tags and MPLS labels, but a second system 102B may only support VLAN tags. As such, the mapping tables and corresponding filter parameters used and shared on each system 102A/102B can be limited to the use of VLAN tags. The filter policy on each system 102A/102B can be configured to apply supported packet modification parameters to packets leaving each system in order to ensure that the receiving system can understand and process the packets.

An example unified mapping table is provided in TABLE 5 where only VLAN tags are used to identify packets, assuming that VLAN tags are the commonly supported parameters.

TABLE 5
EXAMPLE UNIFIED MAPPING TABLE
WITH AGREED CAPABILITIES (e.g., VLAN tags)

| General | | | Packet |
|---|---|---|---|
| Label | System | Local Definition | Modifier |
| Chassis 1, | CHASSIS 1 | Packets entering Chassis | VLAN Tag 1 |
| Port 3 | | 1 on Network Port 3 | |
| Mail Server | CHASSIS 1 | Packets to and from | VLAN Tag 2 |
| Traffic | | server with IP address | |
| | | 192.168.1.5 on TCP port | |
| | | 25 | |
| IPS Server | CHASSIS 1 | The security server | VLAN Tag 3 |
| | | attached to Tool Port 5 | |
| | | on Chassis 1 | |
| Chassis 2, | CHASSIS 2 | Packets entering Chassis | VLAN Tag 5 |
| Port 4 | | 2 on Network Port 4 | |
| Network | CHASSIS 2 | The security server | VLAN Tag 6 |
| Recorder | | attached to Tool Port 2 | |
| | | on Chassis 2 | |

It is further noted that the two packet forwarding systems 102A and 102B can also be configured to share additional information in addition to packet filter parameters and/or mapping table related information. For example, a packet forwarding system where a packet source originates can determine from a destination packet forward system whether or not the destination packet forwarding system is actually using the source packets such that they are in fact being forwarded to further destinations from the destination packet forwarding system. As a further example, if a user has labeled “Mail Server Traffic” as one packet source within the mapping tables available from a first packet forwarding system, and this packet source is not being actively forwarded to further destinations on a destination second packet forwarding system, the destination second packet forwarding system can communicate this lack of or use to the first packet forwarding system. This lack of use information can be used, for example, so that the user of the first packet forwarding system can know that it is safe to remove access to this packet source, or so that the first packet forwarding system can pause forwarding these packets to the second destination packet forwarding system as they are not being used. The second packet forwarding system can also let the first packet forwarding system know when this packet source is being used, and the first packet forwarding system can then restart or being forwarding packets for this packet source to the second packet forwarding system. Other variations and information could also be communicated, as desired, between the packet forwarding systems to further facilitate operations and efficiencies of the overall system with respect to the embodiments described herein.

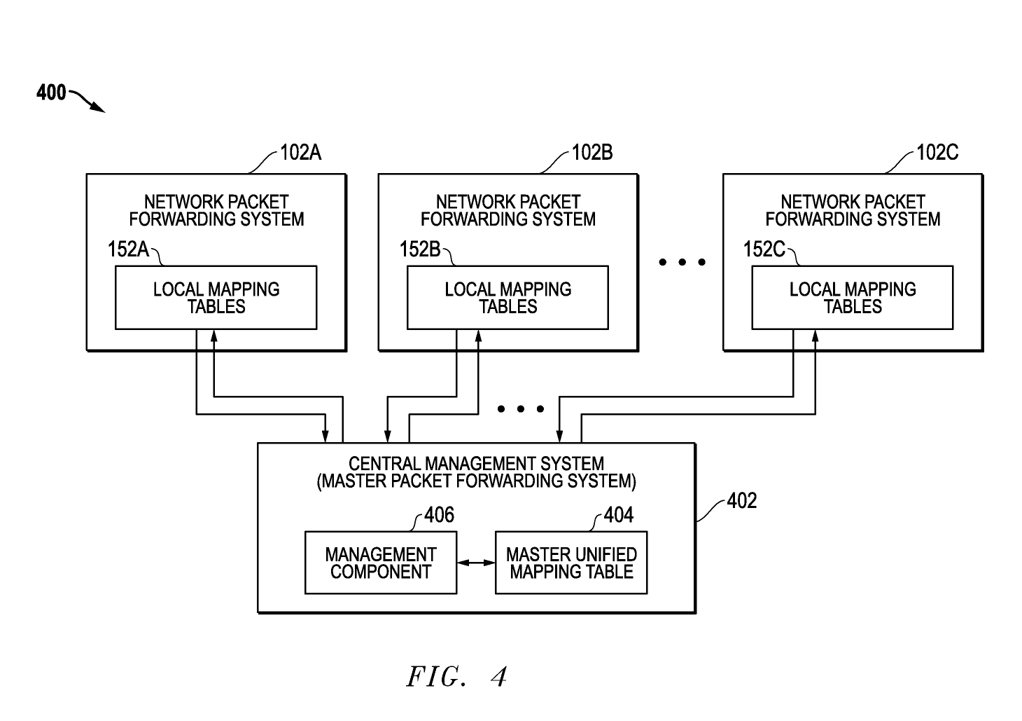

FIG. 4 is a block diagram of an example embodiment for a network environment 400 where a master unified mapping table 404 is stored within a central management system 402. For this example embodiment, each of the network packet forwarding systems 102A, 102B . . . 102C within the network communication system environment 400 communicates source/destination records from its respective local mapping table 152A, 152B . . . 152C to the management component 406 within the central management system 402. The management component 406 stores information from the local source/destination records received from the packet forwarding systems 102A, 102 B 102C within the master unified mapping table 404. Each of the network packet forwarding systems 102A, 102B . . . 102C can then communicate with the central traffic management system 402 and the management component 406 to determine information about available packet sources and/or packet destinations. Once filters 107 are defined using an available source/destination, the master unified mapping table 404 can also be used by the filter processors within the packet forwarding systems 102A, 102B . . . 102C to obtain detailed information about these packet sources/destinations that can be used to generate the rules 108 for the defined filters 107. It is also noted that the central management system 402 can be a packet forwarding system that includes the management component 406 and has been designated as a master system with respect to keeping the master unified mapping table 404. Other variations could also be implemented.

In operation, when the user/administrator of one system wants to configure a new filter within a packet forwarding system, the user can use the general source/destination labels from the master unified mapping table 404. Further, the management component 406 also allows for central policy management across disparate packet forwarding systems 102A, 102B . . . 102C. For example, at the management component 406, an administrator can configure simplified filter descriptions using the source/destination labels such as “send MAIL SERVER traffic to the NETWORK RECORDER.” The management component then sends configuration information and the master unified mapping table 404 to the individual packet forwarding systems 102A, 102B . . . 102C to implement the desired forwarding of packets. As such, the management component 406 allows for management of loosely interconnected systems, which can be of different architectures and capabilities, and allows them to share packets and filter parameters while using human-friendly definitions of traffic sources and destinations.

The following TABLES 6A and 6B provide an example embodiment of filter rules that can be defined on two systems to “send MAIL SERVER traffic to the NETWORK RECORDER,” according to the example above.

TABLE 6A
EXAMPLE FILTER FOR SYSTEM 102A

| Source With Label | Forwarding Actions | Destinations |
|---|---|---|
| Mail Server Traffic | Apply VLAN Tag 2, | System 2 on Port 4 |
| | Pass All | |

TABLE 6B
EXAMPLE FILTERS FOR SYSTEM 102B

| Source with Label | Forwarding Actions | Destinations |
|---|---|---|
| Mail Server Traffic on | VLAN Tag 2, Pass All | Tool Port 2 |
| System 1 | | |

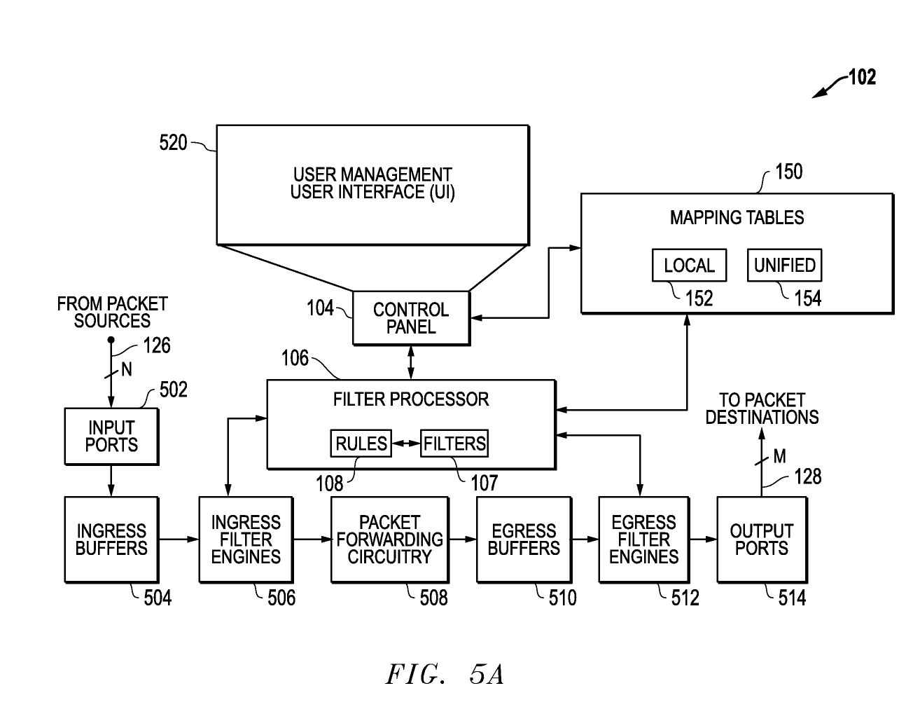

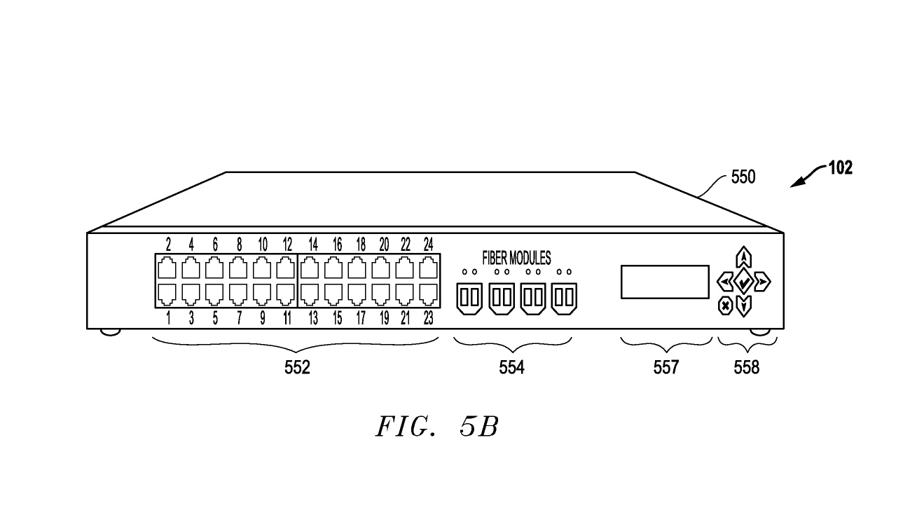

FIG. 5A is a block diagram for an example embodiment for packet forwarding system 102. As described with respect to FIG. 1, the packet forwarding system 102 includes a control panel 104 that provides management access to a user management platform 125. The control panel 104 in part provides a user management user interface (UI) 520 through which a user can define, manage, and control the filters 107. The filter processor 106 for the packet forwarding system 102 processes the filters 107 to generate forwarding rules 108 for filter engines 109. For the embodiment of FIG. 5A, the filter engines 109 are implemented as ingress filter engines 506 and egress filter engines 512, and filter processor 106 applies the forwarding rules 108 to the filter engines 506/512.

In operation, the forwarding rules 108 determine at least in part how the filter engines 506/512 forward packets from input ports 502 to output ports 514 for the packet forwarding system 102 through packet forwarding circuitry 508. The packet forwarding circuitry 508 forwards packets between input ports 502 and output ports 514 based in part upon the forwarding rules 108 set up in the ingress filter engines 506 and the egress filter engines 512. For the embodiment depicted, packets from connections 126 are received at the input ports 502. These packets are then stored in ingress queues or buffers 504 prior to being processed by ingress filter engines 506. Based upon ingress filter rules within the ingress filter engines 506, the packet forwarding circuitry 508 forwards packets to the appropriate output ports 514. However, prior to being sent out through the output ports 514 to external systems, the outgoing packets are first stored in egress queues or buffers 510 and then processed by egress filter engines 512. Based upon egress filter rules within the egress filter engines 512, the egress filter engines 512 forward the appropriate packets to the output ports 514. The output ports 514 are connected to network tools through connections 128. The filter processor 106 communicates with the ingress filter engines 506 and egress filter engines 512 to apply the forwarding rules 108 so that these filter engines will provide the packet forwarding defined by the user filters 107.

It is noted that the packet forwarding system 102 can be implemented using one or more network packet switch integrated circuits (ICs), such as are available from Broadcom Corporation. These switch integrated circuits include input port circuitry, ingress buffer circuitry, ingress filter engine circuitry, switch fabric packet forwarding circuitry, egress buffer circuitry, egress filter engine circuitry, output port circuitry, internal processors and/or other desired circuitry. Further these integrated circuits can include control and management interfaces through which they can be programmed to provide desired forwarding and control. As such, the filter processor 106 can program the filter engines within the network packet switch integrated circuit with appropriate forwarding rules. The packet forwarding system 102 can also include other circuitry and components, as desired. For example, packet forwarding system 102 can include one or more printed circuit boards (PCBs) upon which the network packet switch IC is mounted, power supply circuitry, signal lines coupled to external connections, and a variety of external connectors, such as Ethernet connectors, fiber optic connectors or other connectors, as desired. It is further noted that the packet forwarding system 102 including the filter processor 106 can be implemented using one or more programmable processing devices. For example, the network packet switch ICs can be controlled and operated using a processor, microcontroller, configurable logic device (e.g., CPLD (complex programmable logic device), FPGA (field programmable gate array)), and/or other processing device that is programmed to control these integrated circuits to implement desired functionality. It is further noted that software or other programming instructions used for the packet forwarding system 102 and/or its components, such as filter processor 106 and the control panel 104, can be implemented as software or programming instructions embodied in a non-transitory computer-readable medium (e.g., memory storage devices, FLASH memory, DRAM memory, reprogrammable storage devices, hard drives, floppy disks, DVDs, CD-ROMs, etc.) including instructions that cause processing devices used by the packet forwarding system 102 to perform the processes, functions, and/or capabilities described herein.

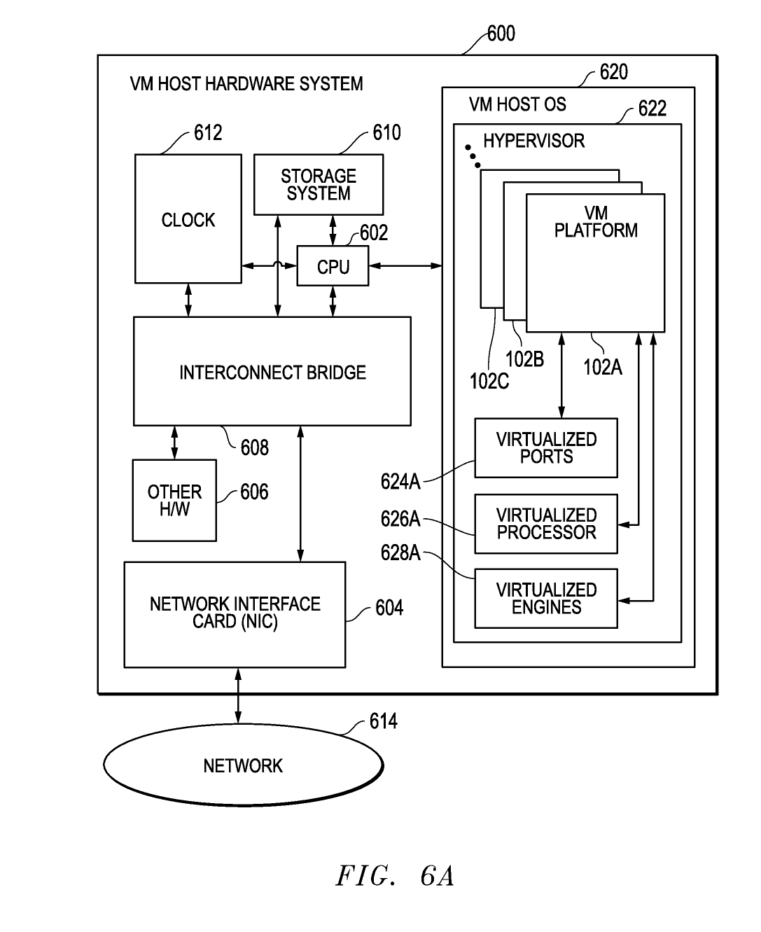

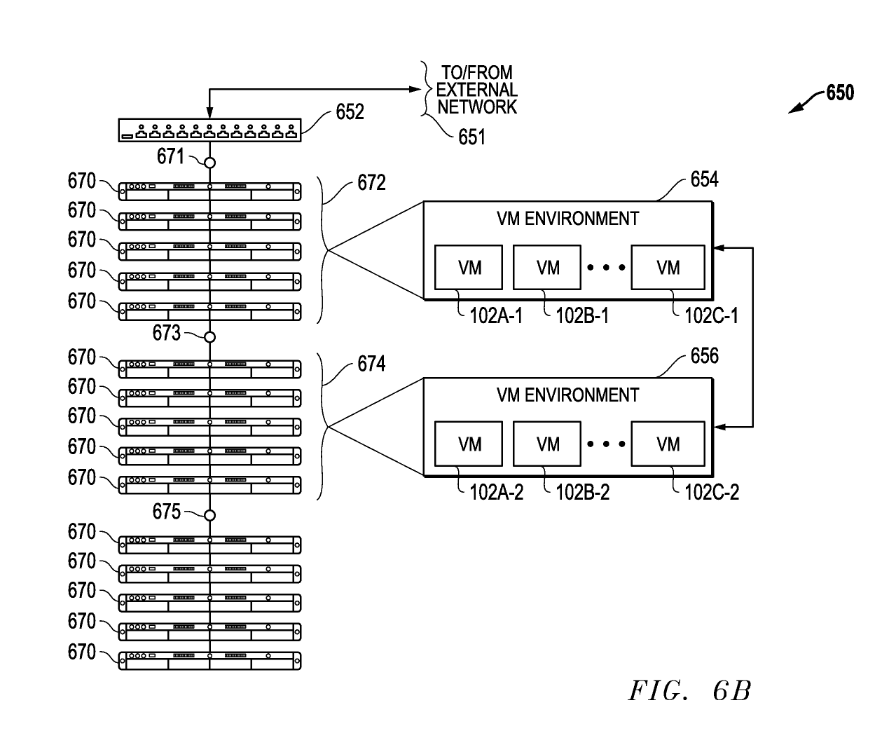

In one embodiment for the packet forwarding system 102, a PCB can include a processor IC separate from a network packet switch IC. The filter processor 106 can then be configured to operate on the separate processor IC, and the separate processor IC can interface with an application programming interface (API) provided by the network packet switch vendor for the network packet switch IC. This API provides an abstracted programmatic interface with which to apply filter rules to the filter engines within a network packet switch IC to control how packets are forwarded by the packet switch IC within the packet forwarding system 102. As described further below with respect to FIGS. 6A-B, the packet forwarding system can also be implemented as one or more virtual machine (VM) platforms operating within a virtual processing environment hosted by one or more host processing systems.

As described herein, the packet forwarding system 102 automatically implements filters 107 as one or more forwarding rules 108 that are applied to filter engines 109, such as ingress filter engines 506 and egress filter engines 512 in FIG. 5A. The forwarding rules 108 represent the internal device specific representations that are used to implement the filter engine rules. For current packet switch ICs, these device specific representations often include programming or provisioning of filter rules into ternary content-addressable memories (TCAMs) within the packet switch ICs. A filter rule typically includes a predicate and one or more action(s). The predicate is one or more traffic-matching criteria that are logically AND-ed together (e.g., TCAM matching criteria such as VLAN ID or Source IP address). Each predicate compares a key to a value. The key is computed by selecting fields from packets based on protocol and content of the packet. An action can be defined by the filtering rule and applied when a match occurs. For current TCAMs (and packet switch IC filter engines), actions typically include where to forward the packet, whether to drop the packet, and/or other desired action(s) with respect to the packet. For example, additional actions can include adding headers, adding identifiers within headers, stripping headers, stripping identifiers within headers, and/or other additional actions to modify packet contents.

Based upon the applied filter rules 108, the filter engines 109, such as ingress filter engines 506 and egress filter engines 512 in FIG. 5A, conditionally direct traffic from the input ports to the output ports. Filter rules can specify a single traffic-matching criteria or they can involve Boolean expressions that logically combine various traffic-matching criteria to represent the desired filtering behavior. Further, the various criteria in the filter may include ranges and/or non-contiguous lists of values which effectively allow for a second level of OR-ing within the filters. In addition, other logic, such as NOT operations, and/or more complicated logic expressions such as source/destination pairs and bidirectional flows could also be represented in filter rules, if desired. A filter's traffic-matching criteria can be configured as desired. For example, matching criteria can be configured to include values in any ISO (International Standards Organization) OSI network layer 2 (L2) through layer 7 (L7) header value or packet content. It is noted that packet-based communications are often discussed in terms of seven communication layers under the OSI model: application layer (L7), presentation layer (L6), session layer (L5), transport layer (L4), network layer (L3), data link layer (L2), and physical layer (L1). Examples of traffic-matching filter criteria for packet-based communications include but are not limited to:
Layer 2 (L2): Source/Destination MAC address, VLAN, Ethertype
Layer 3 (L3): Source/Destination IP address, IP Protocol, Diffserv/TOS
Layer 4 (L4): Source/Destination L4 Port, TCP Control flags

It is noted that these L2-L4 criteria are useful because existing hardware designs for packet switch ICs parse these packet headers. However, packet switch devices can be improved by extending filter capabilities to layers 5-7 (L5-L7), and this additional filtering criteria can be used by the packet forwarding system 102 as well.

FIG. 5B is a diagram of an example embodiment for a product configuration as well as external connections for an example packet forwarding system 102. As depicted, the packet forwarding system 102 includes a housing 550 having external connections for a variety of connector types. For example, Ethernet port connectors 552 can be provided (e.g., Ethernet ports 1-24), and fiber optic connectors 554 can be provided for fiber optic connector modules. Further, a display screen, such a back-lit LCD (liquid crystal display) screen 557, can also be included for displaying information related to the packet forwarding system 102. Direct navigation controls 558 can also be included, for example, for navigating management menus displayed in screen 557. Although not shown, a separate management network port can also be provided, for example, on the back of housing 550. This management network port can provide a control and management network interface to control panel 104 for the packet forwarding system 102. It is further noted that circuitry for the packet forwarding system 102, including PCBs and power supply circuitry, can be mounted within the housing 550. Other variations can also be implemented while still taking advantage of the source label embodiments described herein.

As indicated above, the packet forwarding system can also be implemented as one or more virtual machine (VM) platforms within a virtual processing environment hosted by one or more host processing systems. FIGS. 6A-B provide example embodiments of virtual environments. For example, one or more of the components within the network environment 100 of FIG. 1 can be virtualized such that they operate as one or more VM platforms within a virtual environment. Virtual resources can be made available, for example, through processors and/or processing cores associated with one or more server processing systems or platforms (e.g., server blades) used to provide software processing instances or VM platforms within a server processing system. A virtual machine (VM) platform is an emulation of a processing system that is created within software being executed on a VM host hardware system. By creating VM platforms within a VM host hardware system, the processing resources of that VM host hardware system become virtualized for use within the network communication system. The VM platforms can be configured to perform desired functions that emulate one or more processing systems.

FIG. 6A is a block diagram of an example embodiment for a virtual machine (VM) host hardware system 600 that communicates with a network 614 such as a packet network communication system. For the example embodiment depicted, the VM host hardware system 600 includes a central processing unit (CPU) 602 that runs a VM host operating system 620. An interconnect bridge 608 couples the CPU 602 to additional circuitry and devices within the VM host hardware system 600. For example, a system clock 612, a network interface card (NIC) 604, a data storage system 610 (e.g., memory) and other hardware (H/W) 606 are coupled to the CPU 602 through the interconnect bridge 608. The system clock 612 and the storage system 610 can also have a direct connections to the CPU 602. Other hardware elements and variations can also be provided.

The VM host hardware system 600 also includes a hypervisor 622 that executes on top of the VM host operating system (OS) 620. This hypervisor 622 provides a virtualization layer including one or more VM platforms that emulate processing systems, such as the packet forwarding systems described above, and that provide related processing resources. As shown with respect to VM platform that implements a first packet forwarding system 102A, each of the VM platforms 102A, 102B, 102C . . . is configured to have one or more virtual hardware resources associated with it, such as virtualized ports 624A, a virtualized processor 626A, virtualized filter engines 628A, and/or other virtualized resources. The VM host hardware system 600 hosts each of the VM platforms 102A, 102B, 102C . . . and makes their processing resources and results available to the network 618 through the VM host operating system 620 and the hypervisor 622. As such, the hypervisor 622 provides a management and control virtualization interface layer for the VM platforms 102A-C. It is further noted that the VM host operating system 620, the hypervisor 622, the VM platforms 102A-C, and the virtualized hardware resources 624A/626A/628A can be implemented, for example, using computer-readable instructions stored in a non-transitory data storage medium that are accessed and executed by one or more processing devices, such as the CPU 602, to perform the functions for the VM host hardware system 600.

FIG. 6B is a block diagram of an example embodiment for a server system 650 including multiple VM environments 654 and 674 that host VM platforms implementing packet forwarding systems. For the example embodiment 650, a number of processing system platforms 670, such as blade servers that include VM host hardware systems 600 of FIG. 6A, are connected to an external network communication system through connections 651 and to each other through a router or switch 652. For the example embodiment 650, the processing system platforms 670 are configured into three nominal groups as indicated by nodes 671, 673, and 675. The processing system platforms 670 within each group are managed together to provide virtual processing resources as part of the network communication system. For the example embodiment 650, one group 672 of processing system platforms 670 is used to host a VM environment 654 that includes virtual machine (VM) platforms operating to provide packet forwarding systems 102A-1, 102B-1 . . . 102C-1, respectively. One other group 674 of processing system platforms 670 is used to host a VM environment 656 that includes virtual machine (VM) platforms operating to provide packet forwarding systems 102A-2, 102B-2 . . . 102C-2, respectively. It is noted that other groupings of processing system platforms 670 can also be used, or all of the processing system platforms 670 can be managed individually or as a single unit.

As described herein, each of the VM platforms 102A-1, 102B-1 . . . 102C-1 and 102A-2, 102B-2 . . . 102C-2 can store its own local mapping table 152 and unified mapping table 154, as described above with respect to FIGS. 1-3. Further, one or more of VM platforms can be configured as a central traffic management system 402 having a global unified mapping table 404, as described above with respect to FIG. 4. Source label records can be communicated among the various VM platforms and then stored in the respective mapping tables 150. The VM platforms 102A-1, 102B-1 . . . 102C-1 within VM environment 654 can communicate with each other, with the other VM environment 656, or with other processing systems or virtual environments within server system 650 or the external network. Similarly, the VM platforms 102A-2, 102B-2 . . . 102C-2 within VM environment 656 can communicate with each other, with the other VM environment 654, or with other processing systems or virtual environments within server system 650 or the external network. Further, it is noted that the processing system platforms 670 can be connected to each other by a high-speed communication backbone. Other variations could also be implemented while still taking advantage of the source label techniques described herein.

It is also noted that the operational blocks described herein can be implemented using hardware, software or a combination of hardware and software, as desired. In addition, integrated circuits, discrete circuits or a combination of discrete and integrated circuits can be used, as desired, that are configured to perform the functionality described. Further, programmable integrated circuitry can also be used, such as FPGAs (field programmable gate arrays), ASICs (application specific integrated circuits), and/or other programmable integrated circuitry. In addition, one or more processors running software or firmware could also be used, as desired. For example, computer readable instructions embodied in a tangible medium (e.g., memory storage devices, FLASH memory, random access memory, read only memory, programmable memory devices, reprogrammable storage devices, hard drives, floppy disks, DVDs, CD-ROMs, and/or any other tangible storage medium) could be utilized including instructions that cause computer systems, programmable circuitry (e.g., FPGAs), and/or processors to perform the processes, functions, and capabilities described herein. It is further understood, therefore, that one or more of the tasks, functions, or methodologies described herein may be implemented, for example, as software or firmware and/or other instructions embodied in one or more non-transitory tangible computer readable mediums that are executed by a CPU, controller, microcontroller, processor, microprocessor, or other suitable processing device.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method to control forwarding of network packets, comprising:
storing within a packet forwarding system one or more local source records,
combining one or more source records from a separate packet forwarding system and the one or more local source records to form a unified mapping table, each source record comprising a general label, a description of packet sources, and filter parameters configured to identify the source packets from the packet sources;
allowing configuration of one or more filters using general labels from the unified mapping table, each filter being configured to determine how packets are forwarded by the packet forwarding system;
generating rules for one or more filter engines based upon the one or more filters and the filter parameters within the unified mapping table;
applying the rules to the one or more filter engines within the packet forwarding system;
receiving packets from a network using the packet forwarding system; and
forwarding the received packets using the filter engines within the packet forwarding system so that packets are forwarded based at least in part upon the one or more filters.

2. The method of claim 1, further comprising using the packet forwarding system to receive the one or more source records from the separate packet forwarding system and to store the unified mapping table within the packet forwarding system.

3. The method of claim 1, further comprising using a central management system to receive the source records from both the packet forwarding system and the separate packet forwarding system and to store the unified mapping table within the central management system.

4. The method of claim 1, further comprising exchanging one or more local source records with the separate packet forwarding system.

5. The method of claim 4, further comprising:
communicating between the packet forwarding system and the separate packet forwarding system to determine commonly supported filter parameters; and
communicating only commonly supported filter parameters within local records exchanged between the packet forwarding system and the separate packet forwarding system.

6. The method of claim 1, further comprising exchanging additional information about the source packets with the separate packet forwarding system.

7. The method of claim 6, wherein the additional information comprises use information by the separate packet forwarding system for the source packets.

8. The method of claim 1, further comprising:
storing within the packet forwarding system one or more local destination records; and
combining one or more destination records from the separate packet forwarding system and the one or more local destination records within the unified mapping table, each destination record comprising a general label, a description of a packet destination, and filter parameters configured to identify the packet destination.

9. The method of claim 8, wherein the one or more local source records and the one or more local destination records are stored within a local mapping table within the packet forwarding system.

10. The method of claim 1, further comprising forwarding packets from one or more output ports for the packet forwarding system to one or more network monitoring tools coupled to the one or more output ports.

11. The method of claim 1, wherein the packet forwarding system comprises a virtual machine operating within a virtual environment formed by one or more processing devices.

12. The method of claim 1, wherein the allowing comprises providing a graphical user interface to allow configuration of the one or more filters.

13. The method of claim 1, wherein the filter engines comprise one or more ingress filter engines associated with input ports for the packet forwarding system and one or more egress filter engines associated with output ports for the packet forwarding system.

14. A system to control forwarding of network packets, comprising:
a packet switch within a packet forwarding system having filter engines that determine how network packets are forwarded within the packet forwarding system;
a unified mapping table including one or more source records from a separate packet forwarding system and one or more local source records from the packet forwarding system, each source record comprising a general label, a description of packet sources, and filter parameters configured to identify the source packets from the packet sources;
a user interface for the packet forwarding system to allow configuration of one or more filters using general labels from the unified mapping table, each filter being configured to determine how packets are forwarded by the packet forwarding system; and
a filter processor within the packet forwarding system to generate rules for the filter engines based upon the one or more filters and the filter parameters within the unified mapping table and to apply the rules to the filter engines to forward packets based at least in part upon the one or more filters.

15. The system of claim 14, wherein the packet forwarding system is configured to receive the one or more source records from the separate packet forwarding system and to store the unified mapping table.

16. The system of claim 14, further comprising a central management system configured to receive the source records from both the packet forwarding system and the separate packet forwarding system and to store the unified mapping table.

17. The system of claim 14, wherein the packet forwarding system is further configured to exchange one or more local source records with the separate packet forwarding system.

18. The system of claim 17, wherein the packet forwarding system is further configured to communicate with the separate packet forwarding system to determine commonly supported filter parameters and to send only commonly supported filter parameters within the records exchanged with the separate packet forwarding system.

19. The system of claim 17, wherein the packet forwarding system is further configured to communicate with the separate packet forwarding system to determine additional information about the source packets.

20. The system of claim 19, wherein the additional information comprises use information by the separate packet forwarding system for the source packets.

21. The system, of claim 14, wherein the unified mapping table also includes one or more destination records from the separate packet forwarding system and one or more local destination records from the packet forwarding system, each destination record comprising a general label, a description of a packet destination, and filter parameters configured to identify the packet destination.

22. The system of claim 21, wherein the one or more local source records and the one or more destination records are stored within a local mapping table within the packet forwarding system.

23. The system of claim 14, wherein one or more output ports for the packet forwarding system are coupled to one or more network monitoring tools.

24. The system of claim 14, further comprising one or more processing devices configured to provide a virtual environment, and wherein the packet forwarding system comprises a virtual machine configured to operate within the virtual environment.

25. The system of claim 14, wherein the user interface is a graphical user interface.

26. The system of claim 14, wherein the filter engines comprise one or more ingress filter engines associated with input ports for the packet forwarding system and one or more egress filter engines associated with output ports for the packet forwarding system.
